(19) United States
(12) Patent Application Publication
(10) Pub. No.: US 2024/0207718 A1
(43) Pub. Date: Jun. 27, 2024

(54) LOTTERY TICKETS HAVING SYMBOL SETS AND SYSTEMS AND METHODS OF GENERATING SUCH LOTTERY TICKETS

(71) Applicant: IGT GLOBAL SOLUTIONS CORPORATION, Providence, RI (US)

(72) Inventors: Anthony Lucci, North Kingstown, RI (US); Jeffrey Schertzer, Valrico, FL (US)

(21) Appl. No.: 18/085,860

(22) Filed: Dec. 21, 2022

(51) Int. Cl. A63F 3/06; G07F 17/32

(52) U.S. Cl. CPC A63F 3/0665; G07F 17/329

(57) ABSTRACT

Lottery tickets for a lottery game, and systems and methods for generating and providing such lottery tickets, wherein the lottery tickets each include a base, a background image formed on the base, the background image including at least one structure, one or more boards formed on the structure(s), wherein the boards including a plurality of the symbol sets, and wherein a size and configuration of each of the boards is based on a size and configuration of the structure(s) of the background image.

### BACKGROUND

The present disclosure relates to lottery tickets having symbol sets, and to systems and methods for generating and providing such lottery tickets.

Instant lottery tickets are widely available. Instant lottery tickets may include predetermined win or lose indicia information under one or more covers such as a scratch-off-coating (“SOC”). The covers are used to ensure that the instant lottery ticket has not been previously played. Millions of different types of instant lottery tickets are produced and sold every year.

### BRIEF SUMMARY

In various embodiments, the present disclosure provides a lottery ticket for a lottery game wherein the lottery ticket includes: a base; a background image formed on the base, the background image including a structure; a board formed on the structure on the base, the board including different symbol sets, wherein each of the symbol sets include symbols, wherein a size and configuration of the board is based on a size and configuration of the structure of the background image and a parameter of the lottery game; player symbols formed on the base; a removable cover on the base and covering the player symbols; and a paytable on the base, the paytable indicating different payout amounts associated with different quantities of the symbol sets that are completed based on the player symbols.

In various other embodiments, the present disclosure provides a plurality of lottery tickets for a lottery game including a first lottery ticket and a second lottery ticket. The first lottery ticket includes a first base; a first background image formed on the first base, the first background image including a first structure; a first board formed on the first structure on the first base, the first board including a first plurality of the first symbol sets, wherein each of the first symbol sets include a first plurality of symbols, wherein a size and configuration of the first board is based on a size and configuration of the first structure of the first background image; a first plurality of player symbols formed on the first base; a first removable cover on the first base and covering the first plurality of player symbols; and a first paytable on the base, the first paytable indicating a plurality of different payout amounts associated with different quantities of the symbol sets that are completed based on the first player symbols. The second lottery ticket includes: a second base; a second background image formed on the second base, the second background image including a second structure, wherein the second background image is the same as the first background image, and wherein the second structure is the same as the first structure; a second board formed on the second structure on the second base, the second board including a second plurality of the second symbol sets, wherein each of the second symbol sets include a second plurality of symbols, wherein a size and configuration of the second board is based on a size and configuration of the second structure of the background image, and wherein the second board is different than the first board; a second plurality of player symbols formed on the second base; a second removable cover on the second base and covering the second plurality of player symbols; and a paytable on the base, the paytable indicating a plurality of different payout amounts associated with different quantities of the symbol sets that are completed based on the player symbols.

In various other embodiments, the present disclosure provides a system for generating a lottery ticket, wherein the system includes a processor; and a memory device that stores a plurality of instructions, that when executed by the processor, cause the processor to cause a lottery ticket to be generated. The lottery ticket includes: a base; a background image formed on the base, the background image including a plurality of different structures; a plurality of different boards formed on the plurality of different structures on the base, each of the plurality of different boards including a plurality of the symbol sets, wherein each of the symbol sets include a plurality of symbols, wherein a size and configuration of each of the plurality of different boards is based on sizes and configurations of the plurality of different structures of the background image; a plurality of player symbols formed on the base; a removable cover on the base and covering the plurality of player symbols; and a paytable on the base, the paytable indicating a plurality of different payout amounts associated with different quantities of the symbol sets that are completed based on the player symbols.

Additional features are described in, and will be apparent from, the following Detailed Description and the figures.

### BRIEF DESCRIPTION OF THE SEVERAL VIEWS OF THE DRAWINGS

FIG. 1 is a front view of an example background image for example lottery tickets for a lottery game of one example embodiment of the present disclosure, wherein the background image includes a plurality of different structures.

FIG. 2 is a front view of an example pattern configuration for the structures of the example background image of FIG. 1 in accordance with one example embodiment of the present disclosure, wherein the pattern configuration includes a plurality of different patterns.

FIG. 3 is a front view of example board configuration based on the example pattern configuration of FIG. 2 and the structures of the example background image of FIG. 1 in accordance with one example embodiment of the present disclosure, wherein the board configuration includes a plurality of different boards.

FIG. 4 is a front view of alternative example pattern and board configurations for the structures of the example background image of FIG. 1 in accordance with another example embodiment of the present disclosure.

FIG. 5A is a front view of an example lottery ticket based on the alternative example pattern and board configurations of FIG. 4 in accordance with one example embodiment of the present disclosure and showing the SOCs covering the player letters.

FIG. 5B is a front view of the example lottery ticket of FIG. 5A and showing the SOCs removed from covering the player letters.

FIG. 6 is a front view of another example lottery ticket based on alternative example pattern and board configurations in accordance with another example embodiment of the present disclosure.

FIG. 7 is a front view of another example lottery ticket based on alternative example pattern and board configurations in accordance with another example embodiment of the present disclosure.

FIG. 8 is a flowchart of an example method of providing the example lottery ticket of FIG. 5 in accordance with one example embodiment of the present disclosure.

FIG. 9 shows an example lottery gaming system of one example embodiment of the present disclosure.

### DETAILED DESCRIPTION

In various embodiments, the present disclosure relates to lottery tickets having background image and symbol sets on boards on such background images, and systems and methods of generating and providing such lottery tickets. In various embodiments of the present disclosure, each of a plurality of different lottery tickets for a lottery game includes: a base (such as but not limited to a paper substrate); a background image formed on the base; one or more boards formed on the base and covering one or more parts of the background image; one or a plurality of different symbol sets formed on each board; a plurality of player symbols formed on the base; and a paytable formed on the base that shows the potential payout amounts (such as awards) that can be won based on the symbol sets and the player symbols. In various embodiments, the symbol sets on each board include at least one symbol set and can includes two or more symbol sets. Each lottery ticket has or is associated with zero, one, or a plurality of payout amounts (such as awards) associated with the symbol sets on the boards (and thus that lottery ticket). In various embodiments, the payout amounts (such as the awards) actually providable to a player for each lottery ticket are based on the quantity of symbol sets completed based on the player symbols of that lottery ticket. In various embodiments, the lottery tickets are physical tickets, and in other embodiments the lottery tickets are virtual tickets.

In various embodiments, the symbol sets are words, and the symbols are letters. In various such embodiments, each lottery ticket provided by the lottery gaming system includes: a base; a background image; one or more boards (such as one or more crossword type boards) on the background image and thus on the base (and having one or a plurality of words on each board); a plurality of player letters on the base; a plurality of payout amounts associated with the words on the boards and on the base (and thus that lottery ticket). In various such embodiments, the payout amounts actually provided for each lottery ticket are based on the quantity of words completed based on the player letters on that lottery ticket. In various embodiments, the payout amounts for each lottery ticket are based on one or more other factors related to the symbol sets such as the words on the boards as further described below.

In various embodiments, for each lottery ticket, each board of the lottery ticket includes one or more rows, one or more columns, and a plurality of spaces formed by the combination of any rows and columns. In various embodiments, the symbols (such as the letters) and thus the symbol sets (such as the words) are respectively positioned in the spaces. It should be appreciated that the boards can be alternatively oriented, sized, and configured (such as shaped) in accordance with the present disclosure as further discussed below. It should also be appreciated that in various embodiments the boards are located, sized, configured (such as shaped), and oriented based on the structures of the background image as further explained below.

In various embodiments, one or more non-see through SOCs cover the player symbols on the base, and the player must remove the SOC(s) to see each of the player symbols (such as the player words).

In various embodiments, the symbols on the boards can be covered with a see-through SOC that enables a player to see the symbols on the boards under the see-through SOC and to remove such SOC for each of the symbols on the boards that matches one of the player symbols to enable the player to keep track of or visually see the symbol sets (such as the words) that are uncompleted, partially completed, and fully completed on the boards based on the revealed player symbols as those player symbols are revealed by the player removing the SOCs covering the player symbols. In the example embodiments discussed herein, the see-through SOC(s) over the symbol sets (such as the words) on the boards are not employed for brevity and simplicity.

In various embodiments, zero, one, or more of the symbol sets on zero, one, or more of the boards can include zero, one, or more shared symbols (such as unshared letters) respectively in zero, one, or more spaces of such board.

In various embodiments, each symbol set (such as each word) is either horizontally positioned in a row on one of the boards or is vertically positioned in a column on one of the boards. It should be appreciated that one or more of the symbol sets can be otherwise suitably positioned on the boards (such as diagonally) in accordance with the present disclosure.

In various embodiments, the quantity of the spaces on each board (and thus quantity of the rows and columns) can vary in accordance with the present disclosure. The quantity of spaces, the quantity of symbol sets, the quantity of shared symbols, the quantity of unshared symbols, and/or the arrangements of the symbol sets, the shared symbols, and/or the unshared symbols can be predetermined, randomly determined, or otherwise suitably determined by the gaming system for each lottery ticket. It should further be appreciated that a plurality of the lottery tickets for a lottery game provided by the lottery gaming system can have the same quantity of spaces but two or more of different quantities of symbol sets and/or arrangements of symbol sets.

In various embodiments, for each lottery ticket, the plurality of player symbols includes a plurality of player symbols that are randomly determined for that lottery ticket by the gaming system. In various embodiments, the plurality of player symbols are otherwise suitably determined. In various embodiments, for each lottery ticket, the lottery ticket includes a plurality of different player symbols (such as different player letters). These player symbols can be predetermined, randomly determined, or otherwise suitably determined for each lottery ticket by the lottery gaming system. The quantity of these player symbols for each lottery ticket can vary or be the same for each lottery ticket of a lottery game in accordance with the present disclosure. The quantity of the player symbols on the lottery tickets can vary based on the wager on or purchase price for the lottery ticket in various embodiments. The quantity of the player symbols on the lottery tickets can vary based on one or more other or additional factors for the lottery ticket in various embodiments.

In various embodiments, each lottery ticket indicates multiple different payout amounts (and thus associated awards) for the lottery ticket (even though any particular lottery ticket can be actually associated with zero payout amounts that are paid to the player for the lottery ticket, only one payout amount that is paid to the player for the lottery ticket, a plurality of but less than a maximum quantity of potential payout amounts that are paid to the player for the lottery ticket, or the maximum quantity of payout amounts that are paid to the player for the lottery ticket). In various embodiments, the way for the player to win one or more of the payout amounts is via the revealing of the plurality of the player symbols (such as player letters) on the base and a determination of whether any combinations of the player symbols (such as player letters) form any complete symbol sets (such as complete words) on any of the boards. For this determination, the player can win a payout amount based on the quantity of completed symbol sets (such as the quantity of completed words) on the boards formed by any combinations of the player symbols (such as the player letters). Different quantities of completed symbol sets (such as the different quantities of completed words) on the boards can have different payout amounts associated with such different quantities. In one example embodiment, each completed symbol set (such as each completed word) has an associated payout amount. In other example embodiments, specific quantities of levels of quantities of completed symbol sets (such as completed words) have different associated payout amounts. In various embodiments, the lottery ticket will have a paytable on the base or have a paytable otherwise associated with the lottery ticket that indicates the possible payout amounts.

In various embodiments, the payout amounts for one or more of the completed symbol sets (such as completed words) can be based on a quantity of symbols of that completed symbol set (such as that completed word). For example, completed symbol sets (such as completed words) with a greater quantity of symbols (such as letters) can have higher payout amounts associated with such completed symbol sets (such as completed words) than with a smaller quantity of symbols (such as letters).

In various embodiments, the payout amount for one or more of the completed symbol sets (such as completed words) is independent of the quantity of symbols of that completed symbol set (such as that completed word). For example, each completed symbol sets (such as each completed words) can equally count toward determining any payout amounts regardless of the quantity of symbols (such as letters) of that completed symbol set (such as that completed word).

In various embodiments, the payout amounts for one or more of the completed symbol sets (such as completed words) can be based on the probability of one or more symbols of that completed symbol set (such as that completed word) being a player symbol (such as a player letter). For example, completed symbol sets (such as completed words) with a greater quantity of lower probability symbols (such as lower probability letters) can have higher payout amounts associated with such completed symbol sets (such as completed words) than with completed symbol sets (such as completed words) with a smaller quantity of lower probability symbols (such as lower probability letters). In these embodiments, the likelihood that a player obtains various different player symbols (such as different player letters) can be differently weighted.

As mentioned above, the present disclosure also relates to systems and methods for generating and providing lottery tickets such as but not limited to the above and below described example lottery tickets.

In various embodiments, systems and method of the present disclosure are employed to generate the lottery tickets for a lottery game wherein the lottery tickets each include a background image, and wherein the configuration of one, a plurality, or all of the boards of each of the lottery tickets are based on the background image of the lottery ticket. In various embodiments, all of the lottery tickets for a lottery game have a same background image. In various embodiments, two or more of the lottery tickets for a lottery game have different background images.

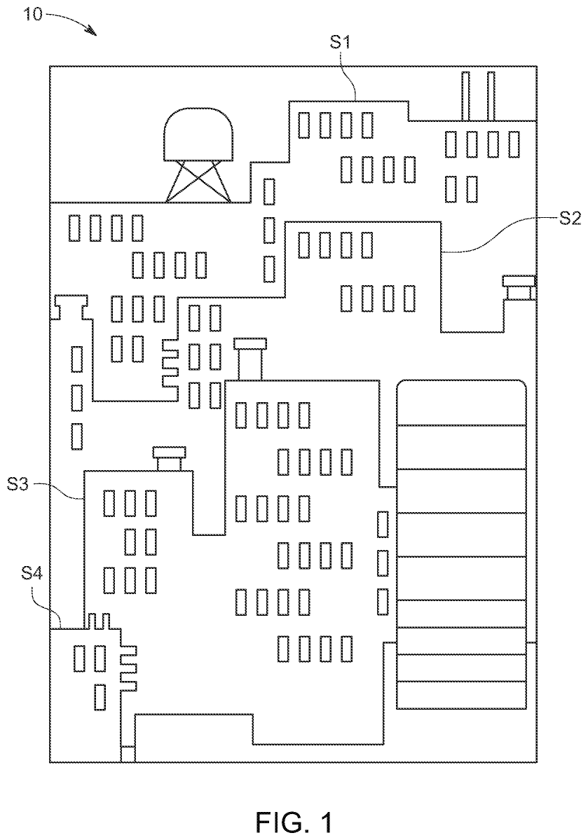

In various embodiments, the systems and methods of the present disclosure contemplate configuring one or more or all of the boards of a lottery ticket based at least in part on the background image for that lottery ticket. In various such embodiments, the systems and methods of the present disclosure configure the boards of a lottery ticket based on the background image for that lottery ticket as further explained with respect to FIGS. 1, 2, 3, 4, 5A, and 5B. In various such embodiments, the systems and methods of the present disclosure can configure different the boards in the same manner or in different manners for lottery tickets for the same lottery game that have the same background image.

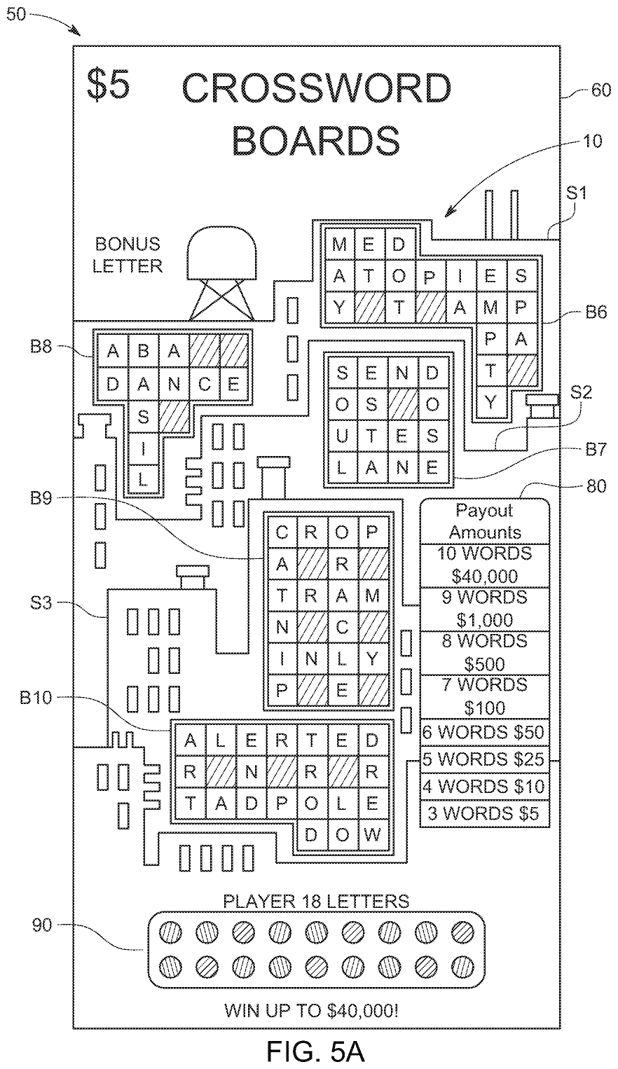

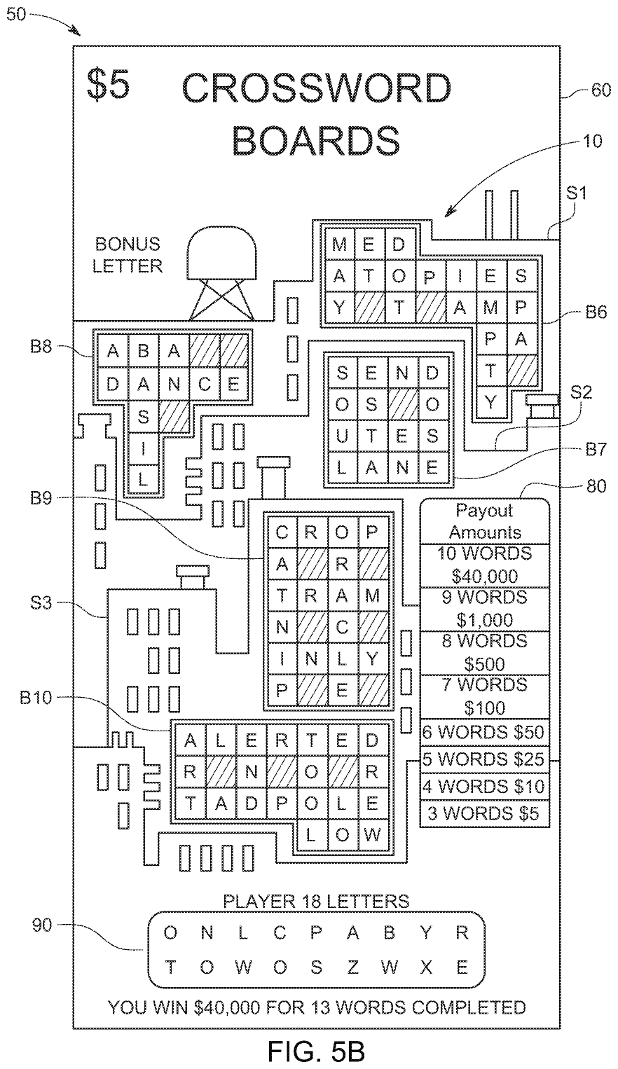

FIG. 1 illustrates an example background image 10 that is selected to be used for a lottery ticket (such as the lottery ticket shown in FIG. 5). The background image 10 includes a plurality of different structures S1, S2, S3, and S4 that provide various boundaries of the background image 10. In this example embodiment, the different example structures S1, S2, S3, and S4 are buildings but it should be appreciated that the structures may be any suitable structures. For example, the structures can be parts of an object (such as a person's face) or parts of an area (such as a geographic location). The structures of each background image can vary in quantity, size, configuration (which includes the shape), and orientation. It should thus be appreciated that the term structures is meant to include any suitable structures, areas, objects, etc. The system and method of various embodiments of the present disclosure determines the boards and the symbols sets on the boards based on the structure(s) of the respective background image such that the boards and symbol sets fit within such structure, do not unduly block such structures, and are configured to be integrated into such structures. The determination can be based on the quantity, size, configuration (which includes the shape), and orientation of each of the structures and on the additional lottery game related parameters such as further discussed below.

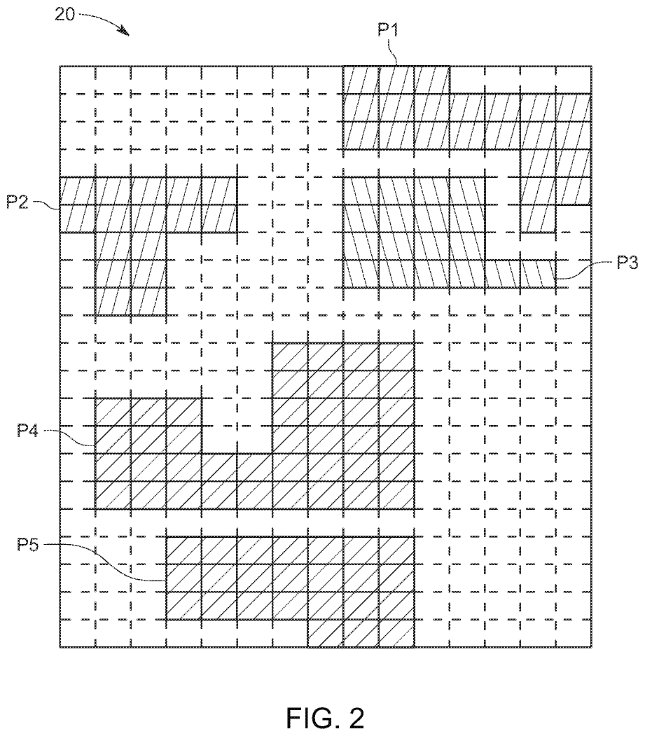

FIG. 2 illustrates an example pattern arrangement 20 that includes a plurality of different patterns P1, P2, P3, P4, and P5 that the system and method generates based on the plurality of different structures S1, S2, S3, and S4 of the example background image 10 (including the boundaries of those structures S1, S2, S3, and S4) and on the additional lottery game related parameters. In this example, the system and method analyzes each of the structures S1, S2, S3, and S4 and determines zero, one, or more suitable patterns for each such structure based on one or more of the quantity, size, configuration (which includes the shape), and orientation of such structures and on one or more and on the additional lottery game related parameters. The additional lottery game related parameters can, as desired and as suitable, include: (1) one or more board parameters for the lottery ticket and lottery game; (2) one or more symbol set parameters for the lottery ticket and lottery game; and/or (3) one or more other lottery game parameters for the lottery ticket and lottery game. For example, the gaming system and method can take into account various parameters such as but not limited to: (1) the desired quantity of symbol sets (such as words) for the lottery game; (2) the maximum and minimum lengths of each symbol set (such as each word) for the lottery game; (3) limits and/or restrictions on the positions and orientation of the symbol sets (such as the words) within each board or pattern; and/or (4) the desired payout amounts for the lottery game.

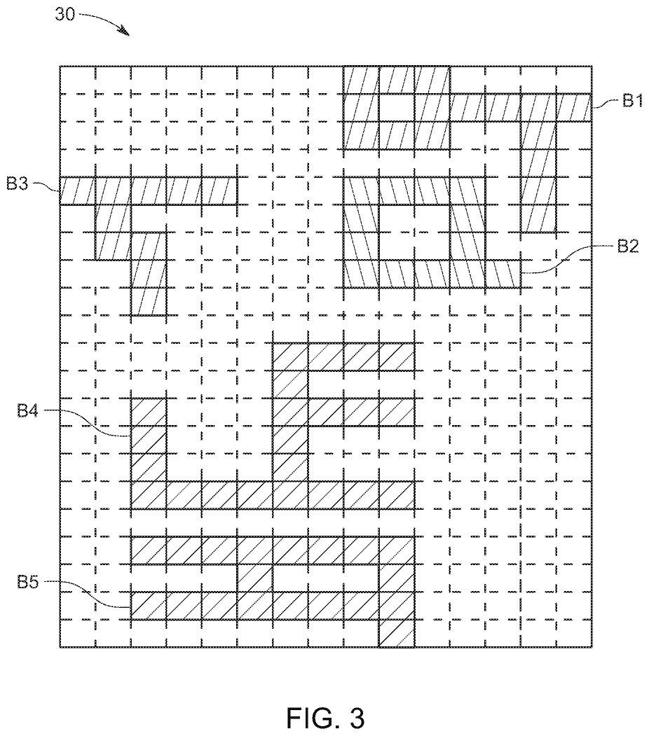

FIG. 3 illustrates an example board arrangement 30 that includes a plurality of different example boards B1, B2, B3, B4, and B5 that the system and method generates based on the plurality of patterns P1, P2, P3, P4, and P5 such that each board is positionable on one of the structures S1, S2, and S3 of the example background image 10 (including the boundaries of those structures S1, S2, S3, and S4). In this example, the system and method analyzes each of the patterns P1, P2, P3, P4, and P5 based on one or more of the quantity, size, configuration (which includes the shape), and orientation of such patterns P1, P2, P3, P4, and P5 and on one or more: (1) board configurations and/or parameters for the lottery ticket and lottery game; (2) symbol set configurations and parameters for the lottery ticket and lottery game; and/or (3) one or more other configurations and parameters for the lottery ticket and lottery game. In this example, since the structure S4 is relatively small, the system and method determines that no board should be placed on that structure. In this example, since the structures S1 and S3 are relatively large, the system and method determines that two boards should be placed on each of those structures. In this example, since the structure S3 is of an intermediate size, the system and method determines that only one board should be placed on that structure. It should be appreciated that in certain embodiments, the system and method can generate one or more blocks and one or more patterns thereon that are positionable outside of one of the structures of the background image. It should be appreciated from this example that the quantities, sizes, configurations (which includes the shapes), and orientations of the boards and the patterns can vary, and can be based on the quantity, sizes, configurations (which includes the shapes), and orientations of the structures of the background image.

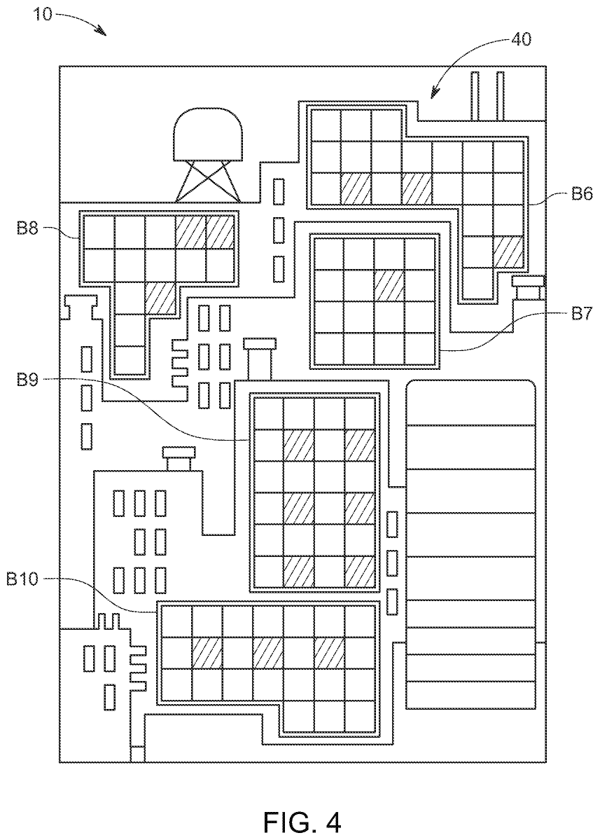

FIG. 4 illustrates an alternative example board arrangement 40 on the background image 10 wherein the board arrangement 40 includes a plurality of different boards B6, B7, B8, B9, and B10 that the system and method generates based on the plurality of patterns P1, P2, P3, P4, and P5 such that each board is positionable on one of the structures S1, S2, and S3 of the example background image 10. In this example, the system and method analyzes each of the patterns P1, P2, P3, P4, and P5 based on one or more of the quantity, size, configuration (which includes the shape), and orientation of such patterns P1, P2, P3, P4, and P5 and one or more desired board configurations and parameters for the lottery ticket and lottery game.

FIGS. 5A and 5B illustrate an example lottery ticket 50 that includes the background image 10 of FIG. 1 and the plurality of different boards B6, B7, B8, B9, and B10 of the board arrangement of FIG. 4 as determined by the system and method for the background image 10. This example lottery ticket 50 illustrates the multiple symbol sets (not labeled) on each of the boards B6, B7, B8, B9, and B10 and those boards on the background images such that the boards and symbol sets fit within such structures of the background image 10, do not unduly block such structures, and are configured to be integrated into such structures. In this example lottery ticket 50, the symbols of the lottery ticket 50 are the letters A through Z that can form symbol sets in the form of words and the player symbols can be selected from the letters A though Z. It should be appreciated that such examples are not meant to limit the present disclosure.

In this example embodiment, the lottery ticket 50 includes a base in the form of a substrate 60, the background image 10 on the base, the boards B6, B7, B8, B9, and B10 (each having a plurality of spaces) formed (such as printed) on the substrate 60 and specifically on the structures S1, S2, and S3 of the background image 10, a plurality of different letters (not individually labeled) formed (such as printed) on the boards B6, B7, B8, B9, and B10 and a plurality of different player letters (not individually labeled but shown in FIG. 5B) formed (such as printed) on the substrate 20. The lottery ticket 10 further includes one or more removable covers such as scratch-off coatings 90 applied on the substrate 60 and initially covering the player letters as shown in FIG. 5A and indicated by the cross-hatching in this example. FIG. 5B shows the lottery ticket 50 with the scratch-off coatings 90 removed from the player letters.

This example lottery ticket 50 also includes a paytable 80 for the payout amounts (such as the possible winnable awards) formed on (such as printed on) the substrate 60. In this example embodiment, the payout amounts are based on the quantity of completed words. In this example, as shown in the paytable 80: (1) completion of 3 words results in a payout amount of $5; (2) completion of 4 words results in a payout amount of $10; (2) completion of 5 words results in a payout amount of $25; (4) completion of 6 words results in a payout amount of $50; (5) completion of 7 words results in a payout amount of $100; (6) completion of 8 words results in a payout amount $500; (7) completion of 9 words results in a payout amount of $1,000; and (8) completion of 10 words results in a payout amount of $40,000. It should be appreciated that the quantities of completed words and associated payout amounts can vary in accordance with the present disclosure. It should be appreciated that the paytable 80 can be positioned on the lottery ticket 50 in any suitable manner. It should be appreciated that the paytable for lottery ticket can be alternatively configured and positioned. In alternative embodiments, the system and method of the present disclosure also determines the location, size, configuration (which includes the shape), and orientation, of the paytable based on the structures of the background image and based on the parameters for the lottery ticket and lottery game.

In this example, the player symbols or player letters are D, N, L, C, P, A, B, Y, R, T, O, W, D, S, Z, W, X, and E. In this example embodiment, there are no repeated letters, but in other example embodiments, one or more player symbols can be repeated. In other embodiments, player symbols cannot be repeated. In this example, the lottery ticket includes the bonus letter K. Various embodiments of the lottery ticket can have zero, one, or more bonus player symbols such as bonus player letters. It should be appreciated that the quantities of player symbols such as player letters can vary in accordance with the present disclosure. It should be appreciated that the player symbols such as the player letters can be positioned on the lottery ticket in any suitable manner. It should be appreciated that the player symbols such as the player letters for lottery ticket can be alternatively configured and positioned. In alternative embodiments, the system and method of the present disclosure also determines the location, size, configuration (which includes the shape), and orientation of the player symbols such as the player letters based on the structures of the background image and the parameters for the lottery ticket and lottery game.

In this example, these player letters form or complete the following symbol sets or words: DOT, SPA, DANCE, SEND, DOSE, LANE, CROP, ORACLE, ALERTED, ART, END, TOOL, LOW, and DREW. In this example, there are thus 14 completed words based on the player letters. In this example, these 14 completed words result in a payout amount of $40,000 won for this example lottery ticket as indicated by the paytable 80 on this lottery ticket 50.

It should be appreciated that in various embodiments, the lottery ticket can include and thus display additional information, such as a lottery ticket identification information (not shown) and/or any other relevant lottery ticket related information (not shown). It should also be appreciated that lottery ticket can be manufactured in various known manners or in new manners for producing physical or virtual lottery tickets. It should be appreciated that the size, configuration (which includes the shape), orientations, and quantity of spaces of the board can vary in accordance with the present disclosure. It should further be appreciated that the quantity of letters, player letters, words, and letters can vary in accordance with the present disclosure.

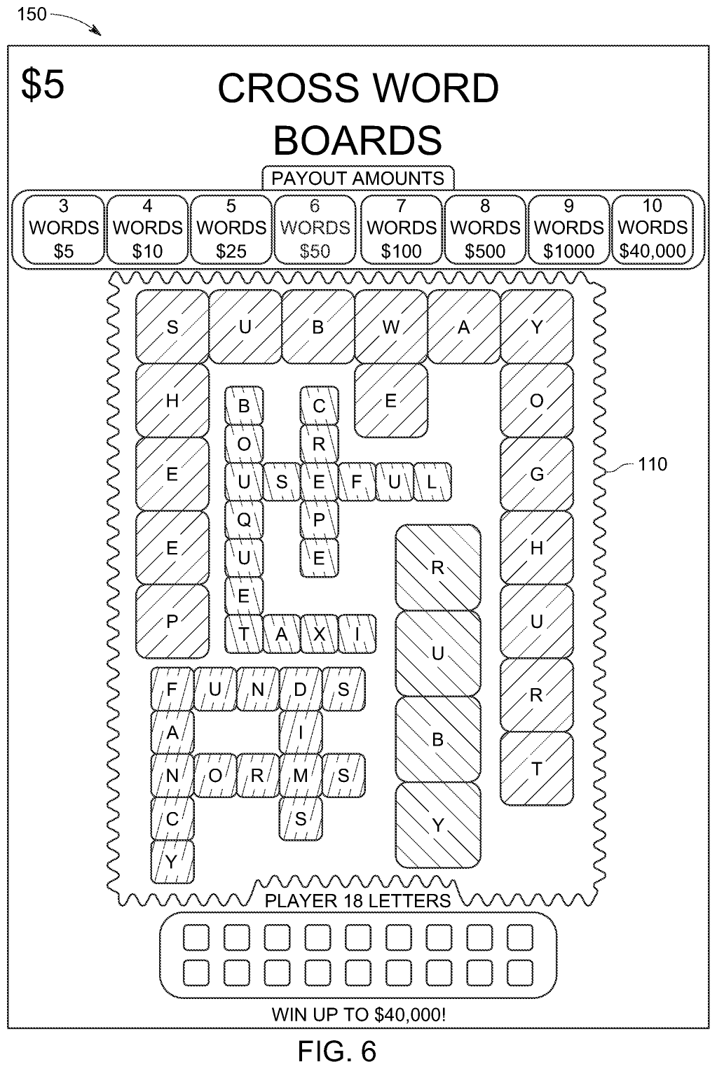

FIG. 6 illustrates another example lottery ticket 150 that includes a background image 110 and the plurality of different boards B11, B12, B13, and B14 as determined by the system and method for the background image 110. This example lottery ticket 150 illustrates the multiple symbol sets (not labeled) on each of the boards B11, B12, B13, and B14. The boards B11, B12, B13, and B14 on the background image 110 fit within such structure of the background image 110. This example lottery ticket shows that the boards can be substantially different sizes, that the spaces for the symbols of the symbol sets on the boards can be of substantially different sizes. This example lottery ticket also shows that the boards can have one or more other distinguishing characteristics such as different colors as represented by the different hash marking on the boards B11, B12, B13, and B14. In various such embodiments, the different size and colored boards can be associated with the same payout levels or can be associated with different payout levels. Thus, in various embodiments, the variations in a feature such as the color and/or size of a pattern (and the blocks and symbol sets on such a pattern) conveys a payout level for that pattern (and the blocks and symbol sets on such a pattern) relative to other patterns (and the blocks and symbol sets on such other patterns). For example, multiple different patterns of different sizes and/or colors (and thus different blocks and different symbol sets on such patterns of different sizes and/or colors) can be used in a lottery game, with each variation conveying a different payout amount to a player. In various such embodiments, if a player completes a symbol set of a specific color, an additional or increased payout amount that is associated with the color can be provided for the lottery ticket.

In alternative embodiments, the boards such as boards B11, B12, B13, and B14 shown in FIG. 6 can be determined independent of the background image 110 and are thus not limited by the boundaries of the background image. In these embodiments, the boards can be in substantially different sizes and the spaces for the symbols of the symbol sets on the boards can be of substantially different sizes. In these embodiments, the boards can have one or more other distinguishing characteristics such as different colors as represented by the different hash marking on the boards B11, B12, B13, and B14. In various such embodiments, the different size and colored boards can be associated with the same payout levels or can be associated with different payout levels. Thus, in various such embodiments, the variations in a feature such as the color and/or size of a pattern (and the blocks and symbol sets on such a pattern) conveys a payout level for that pattern (and the blocks and symbol sets on such a pattern) relative to other patterns (and the blocks and symbol sets on such other patterns). For example, multiple different patterns of different sizes and/or colors (and thus different blocks and different symbol sets on such patterns of different sizes and/or colors) can be used in a lottery game, with each variation conveying a different payout amount to a player. In various such embodiments, if a player completes a symbol set of a specific color, an additional or increased payout amount that is associated with the color can be provided for the lottery ticket. In these embodiments, the various boards can be arranged in any suitable configurations (such as shapes) on the board relative to one another.

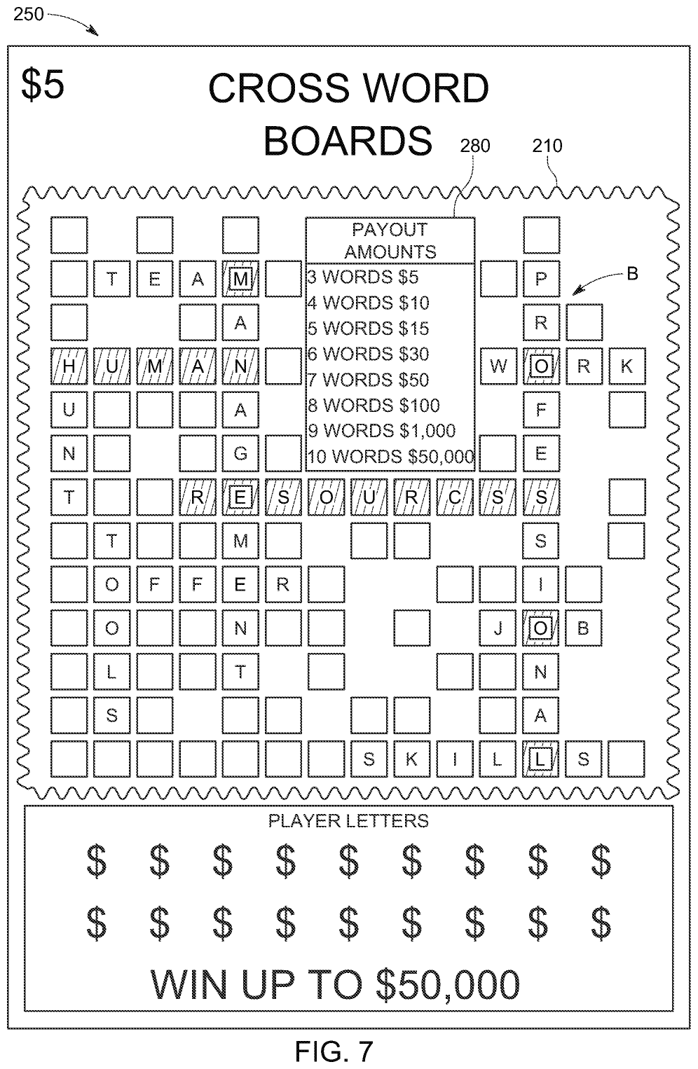

FIG. 7 illustrates another example lottery ticket 250 that includes a background image 210 and a single board B16 determined by the system and method for the background image 210. This example lottery ticket 250 illustrates the multiple symbol sets (not labeled) on the board B16. The example lottery ticket also includes the paytable 280 with the payout amounts on the background image 210 as determined by the system and method of the present disclosure. The board B16 and the paytable 280 fit within such structure of the background image 210. This example lottery ticket shows that the board can be configured to be integrated with the paytable. This example lottery ticket 250 also shows that the board can have one or more other distinguishing characteristics such as different colors as represented by the different hash marking and boxes on the board B16. In various such embodiments, the different colored boards can be associated with the same payout levels or can be associated with different payout levels. In this example, the symbols with the inner squares (which represents a distinguishing feature such as a color) can be associated with additional or enhanced payout amounts such that if the single letter therein matches a player letter, and extra or increased payout amount is provided, and or such that if one of the words that includes such letter is completed, and extra or increased payout amount is provided.

It should be appreciated from the above that in various embodiments, one or more of the boards or the symbol sets can thus include one or more individual symbols (such as individual letters) of specific characteristics (such as colors) that are associated with additional payout amounts if the player symbols (such as any player letter) corresponds with these individual symbols (such as individual letters).

It should also be appreciated from the above that in various embodiments, one or more of the boards can thus include one or more individual spaces of specific characteristics (such as colors) that are associated with additional payout amounts if the player symbols (such as any player letter) corresponds with these individual symbols (such as individual letters) at such spaces.

It should further be appreciated that in various embodiments, the systems and methods of the present disclosure can provide and store a wide range of different pre-configured patterns (as well as boards and symbol sets) such that the boards and symbol sets can then be selected and formed on a substrate based on the background image or other desired characteristic(s) of the lottery ticket for the lottery game. In various such embodiments, the systems and methods can make part of the selections on a random basis.

It should further be appreciated that in other various embodiments, the systems and methods of the present disclosure can generate the patterns (as well as the boards and symbol sets) via specific programming instructions and/or algorithms such that the boards and symbol sets can then formed on a substrate based on the background image or other desired characteristic(s) of the lottery ticket for the lottery game.

These systems and methods are different from conventional crossword game design methods in that the patterns (blocks and symbol sets): (a) are distinguished from one another based on color, size, and/or position within the background image; and/or (b) can be integrated into a background image or they can be “free floating” on a background image. The systems and methods of the present disclosure can thus generate lottery tickets that include: (1) traditional type crossword play where the payout amounts are based on the quantity of words completed in a crossword grid; (2) a secondary play mechanic that assigns specific payout amount (such as bonuses and multipliers) to specific patterns (such as for specific blocks or symbol sets) and where these blocks or symbol sets can be distinguished from each other using different colors and/or sizes; (3) patterns for blocks and symbol sets that can be asymmetrical and may or may not be connected to each other; and/or (4) patterns for blocks that are overlayed or interspersed within a background image and provide a creative way of embedding symbol sets within different structures of background images such as different scenes (such as the symbol sets overlayed onto a city skyline scene, with the blocks and symbol sets falling within the outlines of various structures in the above example embodiments of FIGS. 1 to 5).

In various embodiments, the systems and methods employ digital printing to generate the graphics for both the background images and the blocks and symbol sets.

In various embodiments, the blocks and symbol sets are not hidden below scratch off coatings and will thus be visible to the player through either a similarly sized and colored overprint of the blocks and symbol sets that appears below the overprint or through a translucent marking system, and the payout amounts can be communicated to the player in the play instructions.

In various embodiments, the systems and methods employ programs to create patterns (and the blocks and symbol sets) and to populate these areas based on the background image. This eliminates the need to manually design specific word sets to fit within the background images. In various embodiments, the systems and methods enable an operator using an operator interface of the systems and methods that enable the operator to choose the outer bounds of a grid area, so for example, they could enter a 20 by 20 pattern. At this point, the systems and methods can display a 20 by 20 grid with 240 dark grey or black squares. This initial grid would enable the operator to “click on” individual grid spots, creating the patterns and the blocks within which symbol sets would be populated. The systems and methods can be configured to validate the operators' entries via certain rules such as but not limited to: (1) no words less than 3 letters; (2) no words greater than 9 letters; and (3) no words can be horizonal to each other without an empty space between them. The systems and methods can be configured such that as the operator clicks where symbol sets (such as words) are desired, the systems and methods would store the operator's entries, validate such entries, and display, via a suitable display device of the system, the quantity of words of each symbol set length.

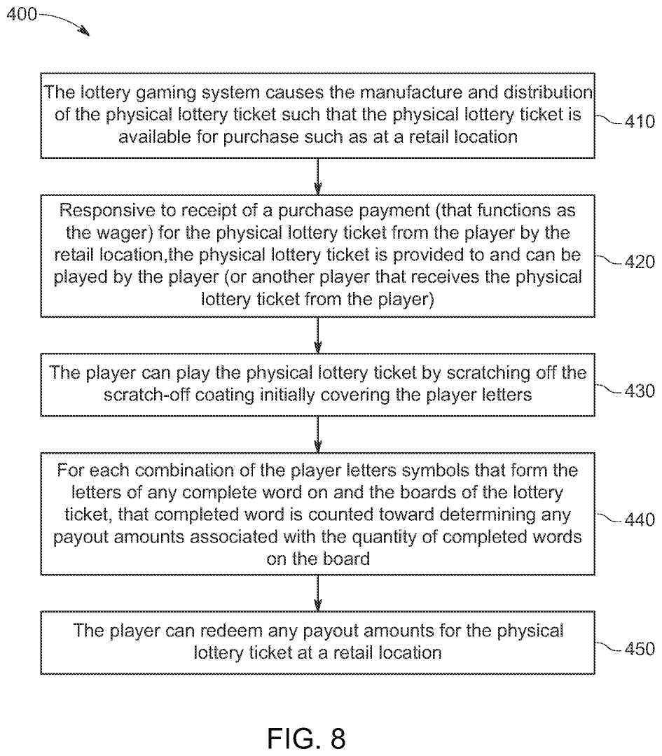

FIG. 8 is a flowchart of an example method 400 of providing an example lottery ticket of the present disclosure, where the lottery ticket is a physical lottery ticket. It should be appreciated that this method will vary if the lottery ticket is a virtual lottery ticket.

In the example method illustrated in FIG. 8, the lottery gaming system causes the manufacture and distribution of the physical lottery ticket such that the physical lottery ticket is available for purchase such as at a retail location, as indicated by block 410. The retail location can, for example, be a retail establishment that sells lottery tickets or can be an electronic lottery ticket provider such as lottery ticket kiosk, or otherwise as explained below. The manufacture of the physical lottery ticket (having a background image) is based on that background image and one or more characteristic of the desired board(s) such as explained above.

Responsive to receipt of a purchase payment (that functions as the wager) for the physical lottery ticket from the player by the retail location, the physical lottery ticket is provided to and can be played by the player (or another player that receives the physical lottery ticket from the player), as indicated by block 420.

The player can play the physical lottery ticket by scratching off the scratch-off coatings initially covering the player letters, as indicated by block 430. The player can do this in any suitable order for the player letters.

For each combination of the player letters that form the letters of any complete word on any of the boards of the physical lottery ticket, that completed word is counted toward determining any payout amount associated with the quantity of completed words on the board, as indicated by block 440. This payout amount (if any) for the lottery ticket is thus based on the quantity of completed words on the board(s) of the lottery ticket.

In the example method illustrated in FIG. 8, the player can redeem any payout amount for the physical lottery ticket at a retail location (such as the retail establishment or lottery ticket kiosk that sold the player the lottery ticket or another suitable retail location), as indicated by block 450.

It should be appreciated from the above that various embodiments of the present disclosure provide a lottery ticket for a lottery game. The lottery ticket includes: a base; a background image formed on the base, the background image including a structure; a board formed on the structure on the base, the board including different symbol sets, wherein each of the symbol sets include symbols, wherein a size and configuration of the board is based on a size and configuration of the structure of the background image and a parameter of the lottery game; player symbols formed on the base; a removable cover on the base and covering the player symbols; and a paytable on the base, the paytable indicating different payout amounts associated with different quantities of the symbol sets that are completed based on the player symbols. In various such embodiments, the background image includes different structures, and which include different boards formed on the structures, each of the board including symbol sets, wherein each of the symbol sets include symbols, wherein the size and configuration of each of the boards is based on the sizes and configurations of the structures of the background image. In various such embodiments, one of the structures has no board formed on said structure. In various such embodiments, the sizes, and configurations of the boards on the structures are additionally based on a quantity of symbol sets for the lottery ticket and maximum and minimum lengths of each symbol set for the lottery ticket. In various such embodiments, the background image includes a plurality of structures and wherein no board is formed on one of said structures. In various such embodiments, the size and configuration of the board is additionally based on at least one of a board parameter, a symbol set parameter, and a lottery game parameter. In various such embodiments, the background image includes different structures, and which includes different boards formed on the structures, each of the board including different symbol sets, wherein the size and configuration of each of the boards is based on the sizes and configurations of the different patterns based on the structures of the background image. In various such embodiments, the background image includes different structures, and which includes different boards formed on the structures, each of the board including different symbol sets, wherein each of the symbol sets includes letters, wherein the player symbols include letters, wherein the size and configuration of each of the boards is based on the sizes and configurations of different patterns based on the structures of the background image. In various such embodiments, the background image includes different structures, and which includes different boards formed on the structures, and wherein a location, size, and configuration of the paytable is based on the structures of the background image. In various such embodiments, the lottery ticket is a physical lottery ticket, wherein the base includes a substrate, the symbol sets are printed on the substrate, the player symbols are printed on the substrate, the removable cover is a scratch-off coating covering the player symbols, and the paytable is printed on the base. In various such embodiments, the lottery ticket is a virtual lottery ticket.

It should further be appreciated from the above that various embodiments of the present disclosure provide a plurality of lottery tickets for a lottery game. The plurality of lottery tickets include a first lottery ticket including: a first base; a first background image formed on the first base, the first background image including a first structure; a first board formed on the first structure on the first base, the first board including a first plurality of the first symbol sets, wherein each of the first symbol sets include a first plurality of symbols, wherein a size and configuration of the first board is based on a size and configuration of the first structure of the first background image; a first plurality of player symbols formed on the first base; a first removable cover on the first base and covering the first plurality of player symbols; and a first paytable on the base, the first paytable indicating a plurality of different payout amounts associated with different quantities of the symbol sets that are completed based on the first player symbols. The second lottery ticket includes: a second base; a second background image formed on the second base, the second background image including a second structure, wherein the second background image is the same as the first background image, and wherein the second structure is the same as the first structure; a second board formed on the second structure on the second base, the second board including a second plurality of the second symbol sets, wherein each of the second symbol sets includes a second plurality of symbols, wherein a size and configuration of the second board is based on a size and configuration of the second structure of the background image, and wherein the second board is different than the first board; a second plurality of player symbols formed on the second base; a second removable cover on the second base and covering the second plurality of player symbols; and a paytable on the base, the paytable indicating a plurality of different payout amounts associated with different quantities of the symbol sets that are completed based on the player symbols. In various such embodiments, the first background image includes a first plurality of different structures, and which includes a first plurality of different boards formed on the first plurality of different structures, wherein the size and configuration of each of the first plurality of different boards is based on the sizes and configurations of the first plurality of structures of the first background image, and the second background image includes a second plurality of different structures, and which includes a second plurality of different boards formed on the second plurality of different structures, wherein the size and configuration of each of the second plurality of different boards is based on the sizes and configurations of the second plurality of structures of the second background image, the second plurality of different structures are the same as the first plurality of structures, and the second plurality of different boards are different than the first plurality of different boards. In various such embodiments, at least one of a location, a size, and a configuration of the first paytable is based on the first plurality of structures of the first background image, and wherein one of a location, a size, and a configuration of the second paytable is based on the second plurality of structures of the second background image. In various such embodiments, the lottery tickets are physical lottery tickets. In various such embodiments, the lottery tickets are virtual lottery tickets.

It should further be appreciated from the above that various embodiments of the present disclosure provide a system for generating a lottery ticket and including a processor and a memory device that stores a plurality of instructions, that when executed by the processor, cause the processor to cause a lottery ticket to be generated. The lottery ticket includes: a base; a background image formed on the base, the background image including a plurality of different structures; a plurality of different boards formed on the plurality of different structures on the base, each of the plurality of different boards including a plurality of the symbol sets, wherein each of the symbol sets include a plurality of symbols, wherein a size and configuration of each of the plurality of different boards is based on sizes and configurations of the plurality of different structures of the background image; a plurality of player symbols formed on the base; a removable cover on the base and covering the plurality of player symbols; and a paytable on the base, the paytable indicating a plurality of different payout amounts associated with different quantities of the symbol sets that are completed based on the player symbols. In various such embodiments, the processor generate a plurality of different patterns based on the plurality of different structures and to generate the plurality of different boards based on the plurality of different patterns. In various such embodiments, the lottery ticket is a physical lottery ticket, wherein the base includes a substrate, the symbol sets are printed on the substrate, the player symbols are printed on the substrate, the removable cover is a scratch-off coating covering the player symbols, and the paytable is printed on the base. In various such embodiments, the lottery ticket is a virtual lottery ticket.

### Example Lottery Gaming Systems—General

In various embodiments of the present disclosure, the lottery tickets are configured to be provided by a lottery agency (such as a state lottery agency) via a lottery gaming system. In various other embodiments of the present disclosure, the lottery gaming system are configured to be operated by a third party that runs the lottery for a lottery agency (such as a state lottery agency).

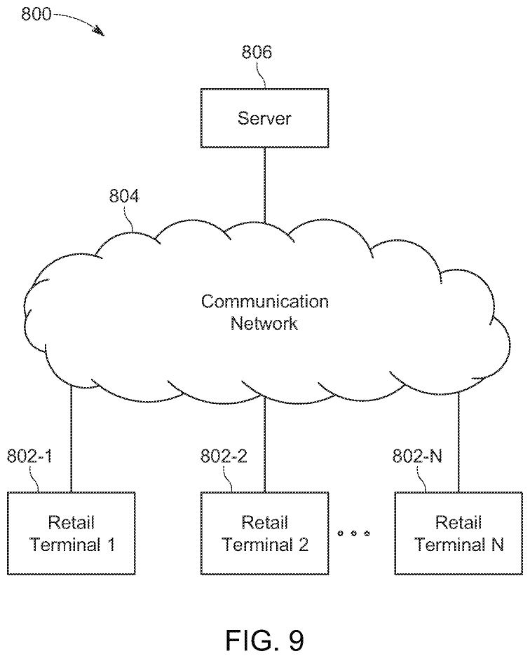

FIG. 9 illustrates an example networked lottery gaming system 800 for certain types of lottery ticket implementations. This example network lottery gaming system 800 generally includes: (1) a plurality of lottery retailer terminals 802-1 to 802-N; (2) a communications network 804; and (3) one or more lottery servers such as lottery server 806. Generally, the retailer terminals 802-1 to 802-N and the lottery server 806 are configured to perform certain functions described above and further described below.

In various embodiments of the lottery gaming system of the present disclosure, the player can purchase a respective physical or virtual lottery ticket via a suitable manner such as, but not limited to, one of the following: (1) a dedicated lottery kiosk (e.g., a lottery kiosk) configured to communicate over a data network (such as the Internet) to a lottery server (such as a lottery server 806 described below in connection with FIG. 9); (2) a retailer-operated lottery terminal configured to communicate over a data network (such as the Internet) to a lottery server (such as a lottery server 806 described below in connection with FIG. 9); (3) a personal computer configured to communicate over a data network (such as the Internet) to a lottery server (such as a lottery server 806 described below in connection with FIG. 9); (4) a personal mobile device (such as a cellular telephone, tablet, or PDA) configured to communicate over a data network (such as a wireless or cellular data network) to a lottery server (such as a lottery server 806 described below in connection with FIG. 9); and/or (5) for physical lottery tickets, from a roll, pack, or book of such physical tickets such as at a retail location.

In the example embodiment of FIG. 9, each retailer terminal 802 corresponds to (or is associated with) a particular lottery retailer. For example, the first retailer terminal 802-1 of FIG. 9 can be associated with a first lottery retailer, such as a convenience store, and the second retailer terminal 802-2 of FIG. 9 can be associated with a second lottery retailer, such as a supermarket. It should be understood that any suitable quantity of lottery retailer terminals can be employed in the lottery gaming system 800, along with any suitable quantity of corresponding lottery servers 806.

In various example embodiments, the lottery retailer terminal 802 includes one or more processor(s). Generally, the processor is operative to perform or process instructions, and in particular, to operate in accordance with the various methods described herein. For example, the processor of the lottery retailer terminal 802 can be operable to enable the lottery retailer terminal 802 to transmit data to (and receive data from) the lottery server 806. More specifically, for physical lottery tickets, the processor can enable the transmission of data representing: (a) a physical lottery ticket pack (including a plurality of lottery tickets) for validation of the physical lottery tickets in that lottery ticket pack; and/or (b) each physical lottery ticket upon a player redeeming that physical lottery ticket at such lottery retailer. For virtual lottery tickets, the processor can enable the transmission of data representing: (a) each virtual lottery ticket for the sale of that virtual lottery ticket; and/or (b) each virtual lottery ticket upon a player redeeming that virtual lottery ticket at such lottery retailer.

In various example embodiments, the lottery retailer terminal 802 includes one or more input device(s). The input devices of the lottery retailer terminal 802 can include components such as an optical scanner and/or a barcode scanner, for reading and/or for deriving information associated with a lottery ticket. For example, a lottery ticket can include registration marks, authenticity data, various codes, micro-printed indicia, one or more sense marks, and/or other lottery indicia that must be read. Examples of additional input devices include, but are not limited to, a keypad, a mouse, an image capturing device (e.g., an optical character recognition (OCR) device), a biometric reader, a portable storage device (e.g., a memory stick), and the like.

In various example embodiments, the input device(s) of one or more of the lottery retailer terminals 802 can include a clock. The clock can be employed to detect, derive and/or append time and/or date information for use by the lottery server 806 to: (i) create a data record corresponding to lottery tickets purchased or redeemed at the lottery retailer terminal 802, (ii) to determine redemption time, round and/or date information associated with lottery tickets, and/or (iii) determine whether a lottery player has redeemed their lottery ticket in a manner that qualifies the player to receive a particular redemption or settlement amount.

In various example embodiments, one or more of the lottery retailer terminals 802 includes one or more output device(s). Such output device(s) can include such components as a display for outputting information to a lottery player or to a terminal operator (e.g., win/loss information and/or payout amounts), one or more benefit output devices (e.g., a cash drawer, a currency dispenser), a printer for producing a physical record (e.g., paper slip, receipt, ticket, voucher, coupon, etc.) that defines a lottery ticket, audio/video output device(s), and the like.

In various example embodiments, one or more of the lottery retailer terminals 802 also includes one or more communications port(s), such as a serial port, a modem or the like. Generally, the communications port of the lottery retailer terminal 802 can be operable to facilitate two-way data communications between (i) the lottery retailer terminal 802, and (ii) the lottery server 806. In accordance with some embodiments, the communications port of the lottery retailer terminal 802 can operate to facilitate the transmission of information between the lottery retailer terminal and a player device such as a personal digital assistant (PDA), cell phone and/or a dedicated (e.g., a proprietary) device.

In various example embodiments, one or more of the lottery retailer terminals 802 includes a data storage device such as a hard disk, optical or magnetic media, random access memory (RAM) and/or read-only memory (ROM), or the like memory device. Generally, the data storage device of the lottery retailer terminal 802 stores a software program, the software program enabling a processor of the retailer terminal 802 to perform various functions including some or all of the various steps described herein. For example, in accordance with certain embodiments, the lottery retailer terminal 802 can be configured to perform some or all of the functions of the lottery server 806 (and vice versa) such that the lottery server 806 and the lottery retailer terminal 802 can be considered as the same “device.”

In various example embodiments, a lottery ticket sales device can be utilized in place of a lottery retailer terminal 802. Such a lottery ticket sales device can be implemented as a lottery server, a controller, a dedicated hardware circuit, an appropriately programmed general-purpose computer, or any other equivalent electronic, mechanical, or electro-mechanical device. Thus, in various embodiments, a lottery ticket sales device can include, for example, but is not limited to: (1) a video lottery terminal that can include a touch sensitive screen for use by a player; (2) a personal computer (e.g., which communicates with a remote lottery server); or (3) a personal mobile device such as a mobile telephone, a tablet, or a personal digital assistant. The lottery ticket sales device can include any or all of the devices of the aforementioned systems.

In this example embodiment, the lottery server 806 operates to: (1) receive and/or store data associated with one or more lottery tickets including such data as: (a) ticket identifier(s), and (b) ticket indicia; (2) determine at least a first redemption amount associated with a lottery ticket; (3) receive a redemption request associated with the lottery ticket; (4) determine a time of play associated with the redemption request; and (5) transmit an indication of the appropriate redemption amount to a lottery retailer terminal (e.g., for output or display to a lottery player and/or lottery terminal operator).

In various example embodiments, the lottery server 806 includes one or more processor(s). Such a processor functions to process instructions, and in particular, to operate in accordance with various methods described herein. For example, the processor can operate to enable the lottery server 806 to transmit data to (and receive data from) the lottery retailer terminal 802. More specifically, the processor of the lottery server 806 can enable the transmission of data representing a lottery ticket, as well as information defining one or more payout(s) associated with that lottery ticket to or by a specific one of the lottery retailer terminals 802 shown in the lottery network 800 of FIG. 9. Thus, the lottery server 806 can be implemented as a system controller, a dedicated hardware circuit, an appropriately and particularly programmed general-purpose computer, or any other equivalent electronic, mechanical, or electro-mechanical device capable of providing for one or more of the embodiments described herein.

In various example embodiments, the lottery server 806 includes one or more input device(s). Examples of such input devices include a keypad, a mouse, a touchscreen, a random number generator, a microphone, and other digital or analog input devices.

In various example embodiments, the lottery server 806 also includes one or more output device(s). Example of output device(s) of the lottery server 806 include a monitor or other display for outputting information to an operator of the lottery server 806 (e.g., for displaying information such as statistical or sales data, win and loss information and/or payout amounts), a printer for producing a physical record (e.g., a report) of such data, and the like. In addition, the lottery server 806 can include one or more communications ports, such as a serial port, modem or the like, operable to facilitate two-way data communications between (i) the lottery server 806 and (ii) one or more lottery retailer terminals 802.

In various example embodiments, the lottery server 806 includes a data storage device (e.g., a hard disk or hard drive, a media-based (removable) memory, or the like). In certain embodiments, the data storage device of the lottery server 806 stores at least one software program, which includes a program to enable the processor of the lottery server 806 to perform some or all of the various steps and functions of at least one implementation of the methods described in detail herein. In addition, the data storage device of the lottery server 806 can operate to store one or more databases including a lottery ticket database and a lottery ticket redemption status database.

In various example embodiments, the lottery server 806 includes a lottery ticket server device that is located at a lottery ticket printing facility and can also function to manage the ticket printing process. The lottery server 806 can also function to develop a lottery game matrix (e.g., determining base payouts, win frequencies, and the like) and to match static lottery content with secure paytable (or payout distribution) data. In certain embodiments, a lottery ticket printer device for use in such lottery gaming systems can utilize the game matrix information from the lottery server and can apply it to the secure paytable data.

In certain example embodiments, a retailer terminal (such as the first retailer terminal 802-1) of FIG. 9 is configured to perform some or all of the functions of the lottery server 806. Thus, in certain example embodiments, the lottery server 806 and the retailer terminal (such as the first retailer terminal 802-1) (or another given retailer terminal and server pairing) can be considered as the same “device.”

Generally, the communications network 804 of FIG. 9 includes one or more local and/or wide-area network(s) proprietary and/or public network(s) (e.g., the Internet) for facilitating two-way data communications between the retailer terminals 802 and the lottery server 806. The lottery server 806 can communicate with lottery retailer terminals 802 directly or indirectly, via a wired or wireless medium, such as via the Internet, via a local area network (LAN), via a wide area network (WAN), via an Ethernet, via a Token Ring, via a telephone line, via a cable line, via a radio channel, via an optical communications line, via a satellite communications link, or via any other appropriate communications system or combinations thereof. Any number and type of devices can be in communication with the lottery server 806, and communication between the lottery retailer terminals 802 and the lottery server 806 can be direct or indirect. A variety of communications protocols can be part of any such communications system, including, but not limited to: Ethernet (or IEEE 802.3), SAP, ATP, Bluetooth™, and TCP/IP.

It should be understood that devices in communication with each other need not be continually transmitting to each other. On the contrary, such devices need only transmit to each other as necessary, and can actually refrain from exchanging data most of the time. For example, a device in communication with another device via the Internet may not transmit data to the other device for days or weeks at a time. In some embodiments, a server may not be necessary and/or preferred. For example, in one or more embodiments, methods described herein can be practiced on a stand-alone gaming device and/or a gaming device in communication only with one or more other gaming devices. In such an embodiment, any functions described as performed by the computer can instead be performed by one or more gaming devices.

As used herein, a lottery retailer can include a merchant who sells lottery tickets at a particular location, authenticates winning lottery tickets, redeems authenticated winning lottery tickets, and/or provides payout amounts (such as awards) to players for winning lottery tickets. Examples of various lottery retailers include, but are not limited to, convenience stores, gas stations, supermarkets, and gaming establishments.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery ticket for a lottery game, the lottery ticket comprising:
a base;
a background image formed on the base, the background image comprising a structure;
a board formed on the structure on the base, the board comprising different symbol sets, wherein each of the symbol sets comprise symbols, wherein a size and configuration of the board is based on a size and configuration of the structure of the background image and a parameter of the lottery game;
player symbols formed on the base;
a removable cover on the base and covering the player symbols; and
a paytable on the base, the paytable indicating different payout amounts associated with different quantities of the symbol sets that are completed based on the player symbols.

2. The lottery ticket of claim 1, wherein the background image comprises different structures, and which comprises different boards formed on the structures, each of the board comprising symbol sets, wherein each of the symbol sets comprise symbols, wherein the size and configuration of each of the boards is based on the sizes and configurations of the structures of the background image.

3. The lottery ticket of claim 2, wherein one of the structures has no board formed on said structure.

4. The lottery ticket of claim 2, wherein the sizes and configurations of the boards on the structures are additionally based on a quantity of symbol sets for the lottery ticket and maximum and minimum lengths of each symbol set for the lottery ticket.

5. The lottery ticket of claim 1, wherein the background image comprises a plurality of structures and wherein no board is formed on one of said structures.

6. The lottery ticket of claim 1, wherein the size and configuration of the board is additionally based on at least one of a board parameter, a symbol set parameter, and a lottery game parameter.

7. The lottery ticket of claim 1, wherein the background image comprises different structures, and which comprises different boards formed on the structures, each of the board comprising different symbol sets, wherein the size and configuration of each of the boards is based on the sizes and configurations of the different patterns based on the structures of the background image.

8. The lottery ticket of claim 1, wherein the background image comprises different structures, and which comprises different boards formed on the structures, each of the board comprising different symbol sets, wherein each of the symbol sets comprise letters, wherein the player symbols comprise letters, wherein the size and configuration of each of the boards is based on the sizes and configurations of different patterns based on the structures of the background image.

9. The lottery ticket of claim 1, wherein the background image comprises different structures, and which comprises different boards formed on the structures, and wherein a location, size, and configuration of the paytable is based on the structures of the background image.

10. The lottery ticket of claim 1, which is a physical lottery ticket, wherein the base comprises a substrate, the symbol sets are printed on the substrate, the player symbols are printed on the substrate, the removable cover is a scratch-off coating covering the player symbols, and the paytable is printed on the base.

11. The lottery ticket of claim 1, which is a virtual lottery ticket.

12. A plurality of lottery tickets for a lottery game comprising:
a first lottery ticket comprising
a first base;
a first background image formed on the first base, the first background image comprising a first structure;
a first board formed on the first structure on the first base, the first board comprising a first plurality of the first symbol sets, wherein each of the first symbol sets comprise a first plurality of symbols, wherein a size and configuration of the first board is based on a size and configuration of the first structure of the first background image;
a first plurality of player symbols formed on the first base;
a first removable cover on the first base and covering the first plurality of player symbols; and
a first paytable on the base, the first paytable indicating a plurality of different payout amounts associated with different quantities of the symbol sets that are completed based on the first player symbols; and
a second lottery ticket comprising
a second base;
a second background image formed on the second base, the second background image comprising a second structure, wherein the second background image is the same as the first background image, and wherein the second structure is the same as the first structure;
a second board formed on the second structure on the second base, the second board comprising a second plurality of the second symbol sets, wherein each of the second symbol sets comprise a second plurality of symbols, wherein a size and configuration of the second board is based on a size and configuration of the second structure of the background image, and wherein the second board is different than the first board;
a second plurality of player symbols formed on the second base;
a second removable cover on the second base and covering the second plurality of player symbols; and
a paytable on the base, the paytable indicating a plurality of different payout amounts associated with different quantities of the symbol sets that are completed based on the player symbols.

13. The lottery tickets of claim 12, wherein
the first background image comprises a first plurality of different structures, and which comprises a first plurality of different boards formed on the first plurality of different structures, wherein the size and configuration of each of the first plurality of different boards is based on the sizes and configurations of the first plurality of structures of the first background image, and
the second background image comprises a second plurality of different structures, and which comprises a second plurality of different boards formed on the second plurality of different structures, wherein the size and configuration of each of the second plurality of different boards is based on the sizes and configurations of the second plurality of structures of the second background image,
the second plurality of different structures are the same as the first plurality of structures, and
the second plurality of different boards are different than the first plurality of different boards.

14. The lottery ticket of claim 13, wherein one of a location, a size, and a configuration of the first paytable is based on the first plurality of structures of the first background image, and wherein one of a location, a size, and a configuration of the second paytable is based on the second plurality of structures of the second background image.

15. The lottery tickets of claim 12, which are physical lottery tickets.

16. The lottery tickets of claim 12, which are virtual lottery tickets.

17. A system for generating a lottery ticket, the comprising:
a processor; and
a memory device that stores a plurality of instructions, that when executed by the processor, cause the processor to cause a lottery ticket to be generated, the lottery ticket comprising:
a base;
a background image formed on the base, the background image comprising a plurality of different structures;
a plurality of different boards formed on the plurality of different structures on the base, each of the plurality of different boards comprising a plurality of the symbol sets, wherein each of the symbol sets comprise a plurality of symbols, wherein a size and configuration of each of the plurality of different boards is based on sizes and configurations of the plurality of different structures of the background image;
a plurality of player symbols formed on the base;
a removable cover on the base and covering the plurality of player symbols; and
a paytable on the base, the paytable indicating a plurality of different payout amounts associated with different quantities of the symbol sets that are completed based on the player symbols.

18. The system of claim 17, wherein the plurality of instructions, when executed by the processor, cause the processor to generate a plurality of different patterns based on the plurality of different structures and to generate the plurality of different boards based on the plurality of different patterns.

19. The system of claim 17, wherein the lottery ticket is a physical lottery ticket, wherein the base comprises a substrate, the symbol sets are printed on the substrate, the player symbols are printed on the substrate, the removable cover is a scratch-off coating covering the player symbols, and the paytable is printed on the base.

20. The system of claim 17, wherein the lottery ticket is a virtual lottery ticket.
